(19) United States
(12) Patent Application Publication
(10) Pub. No.: US 2018/0156259 A1
(43) Pub. Date: Jun. 7, 2018

(54) Micro-Standoff for Blind Holes

(71) Applicant: Penn Engineering & Manufacturing Corp., Danboro, PA (US)

(72) Inventor: Jacques Abboud, Pipersville, PA (US)

(21) Appl. No.: 15/834,053

(22) Filed: Dec. 6, 2017

Related U.S. Application Data
(60) Provisional application No. 62/430,830, filed on Dec. 6, 2016.

(51) Int. Cl. F16B 37/06; F16B 5/02

(52) U.S. Cl. CPC F16B 37/067; F16B 5/02

(57) ABSTRACT

A standoff fastener for attaching to a blind hole in a metal panel. The fastener has a substantially cylindrical body with a short shank that extends downwardly from the body into the hole. The shank has an inwardly extending collar with a first inwardly facing chamfer on the top and a second outwardly facing chamfer located on the bottom. The body has a shoulder at the bottom with a circular recess adjacent to and encircling the shank. The shank is radially divided into four equal segments which are separated by four radial slots. When the shank is spread outwardly by a center installation punch pressing against the first chamfer, the outer distal edge of the shank is pressed into the side wall of the hole, while an edge at the top of the second chamfer embeds into the end wall of the hole.

### RELATED APPLICATIONS

This is a non-provisional patent application based upon provisional patent application 62/430,830 filed Dec. 6, 2016 entitled, “Micro-Standoff for Blind Holes”, which is incorporated herein by reference and priority from which is hereby claimed.

### FIELD OF THE INVENTION

The present invention relates to an internally-threaded fastener that rigidly attaches to a blind hole of a metal substrate. More particularly, the invention relates to fastener with projecting barbs that flare outwardly normal to the fastener's axis of symmetry into the side walls of the mounting hole.

### BACKGROUND OF THE INVENTION

There are many known fasteners that have a shank that expands within and deforms the sidewalls of an unthreaded hole to form a firm grip. Since performance is highly affected and proportional to how much grip surface is available, this fastening mechanism approaches its limits in micro-assemblies where wall heights are very small, such as on the order of fractions of a millimeter, e.g. 0.2 mm in a 0.5 mm total substrate thickness with blind mounting holes of approximately 1 mm in diameter. On this small scale, contact with side wall is not enough, and the search for extra grip areas for mechanical bonding or even for totally different means of attachment is challenging but highly needed.

In order to achieve the required push out and torque out resistances of a standoff, the prior art discloses relatively expensive means that are sometimes inefficient and inadequate to meet the challenges of micro-components. For example, micro-rivets are only possible when there is a double-sided access to the panel. In other words, the hole runs through the entire panel thickness and the gripping occurs on the side wall of the mounting hole as well as on the top and bottom surfaces of the substrate. This is an inadequate solution for blind holes and single-sided access panels.

Where a solution is of extremely high need and of vital importance to the functioning of the smart device, some top-tier microelectronic companies are milling standoffs an integral part of the substrate during the machining process of the substrate itself, the latter representing the outer shell of the device. This process starts with a very thick block of material, which is milled to form the standoffs and desired substrate thickness. During this process, a large amount if substrate material is wasted. This process is time-consuming, inefficient and expensive. In addition, the standoff and substrate panel material are the same, which may be inconvenient when thermal or electrical insulation is needed.

Adhesives are another inefficient and expensive way to attach the micro-standoff to the substrate. The messy appearance and the uncontrolled thickness of an adhesive are major disadvantages. Additionally, the correct chemical formula suitable for similar and dissimilar standoff/substrate materials must be formulated. Light curing and curing time also add to the undesirability of this approach.

Conventional and laser-welding are only applicable for metallic standoffs and substrates. Furthermore, this process is expensive since high current is involved, and is most often inefficient for ultra-thin substrates where cosmetic appearance is of critical importance. Often times, the heat-affected zone exceeds the total substrate thickness (e.g. 0.5 mm) leading to permanent witness marks and discoloration on the other side of the substrate.

It is therefore desirable to provide a fastener that will rigidly attach to very thin panels with a cosmetically acceptable appearance using an efficient manufacturing assembly process.

### SUMMARY OF THE INVENTION

The present invention provide a fastener, and method of installation, that will rigidly attach to very thin panels with a cosmetically acceptable appearance using an efficient manufacturing assembly process. The fastener can be attached to a very thin panel without a reveal or witness mark on the opposite side. The connection is achieved using a radial clinch process that minimizes the compressive force applied to the receiving panel. In once preferred embodiment, the fastener comprises an internally-threaded, standoff fastener. The fastener is substantially cylindrical and has a body and a short shank, which extends downwardly from the body. The shank has an internal bore, which has a diameter less than the minor diameter of the bore in the body. A cavity forms a circular recess around the bottom of the fastener body.

A first inward chamfer is located on the top of the shank at the base of the body and a second outward chamfer is located at the distal bottom end of the shank. The top of the first chamfer has a corner that engages the end wall of the blind hole. During installation, the outer surface of the shank is spread outwardly and grips the side wall of the hole. The shank is radially divided into four equal segments or barbs, which are separated by four radial slots.

More specifically, the invention comprises a unitary clinch nut having a body with upper and lower ends, a base, a central axis, and an axial threaded bore. A shank extends downwardly from the base of the body. The shank has a coaxial, longitudinal bore, a cylindrical outer surface, and an inwardly projecting circular collar at the bottom of the shank. The collar preferably has an inside that is smaller than the body bore. A tapered bearing surface on the top of the collar projects inwardly in the downward direction. The bearing surface is at preferably oriented at a 45-degree angle with respect to the central axis. The bottom of the collar includes a second downwardly-divergent chamfer.

In one embodiment, an area of the nut at the junction of the body and the shank is an area of relative weakness because it has the smallest lateral wall thickness. To facilitate cold deformation of panel material, the nut includes a peripheral shoulder around the base of the body. The shoulder has a cavity encircling and adjacent to the shank. A cylindrical inner wall of the collar extends between the bearing surface and the chamfer. The outside of the shank is otherwise featureless except for a plurality of radial slots dividing the shank into segments.

The is used to rigidly attach to a cylindrical blind hole having generally parallel side walls and a substantially planar end wall perpendicular to the side walls. As further described below, the nut can be rigidly affixed to the panel by penetration of a bottom outer edge of the shank into the side walls while an inner edge of the shank penetrates into the end wall. To determine the degree of panel penetration, the nut has a peripheral shoulder around the base of the body that abuts the top side of the panel.

The invention also includes a method of rigidly affixing the fastener to the panel. Initially, the bottom side of a panel is placed against an anvil. The panel has a top surface with an upward facing blind hole, which has parallel sides and an end wall. Then, the above-described fastener is placed on the top surface of the panel with the shank extending downwardly from into the hole. Finally, a downward force as applied to a punch passing axially through the body bore, extending into the shank bore and pressing against the collar of the shank, which is spread outwardly and downwardly, simultaneously penetrating into the sides and the end wall of the panel hole.

To better accomplish this method of attachment, the punch has a tapered pressing head for displacing the collar of the shank outwardly. Furthermore, the punch is preferably constructed such that the end wall of the hole provides a stop against the downward motion of the punch when the shank is fully displaced and has penetrated the end wall. Preferably, in a final step of the assembly process, the downward force applied to the punch is stopped after the punch contacts the end wall. The downward motion may be stopped by the resistance of the end wall against the punch.

When assembly begins, the fastener is first positioned on the receiving panel with the shank extending into the panel's blind receiving hole. Next, a press punch is placed in contact with the first body chamfer while the panel is supported on its underside by an anvil. The punch has a chamfer that preferably matches the chamfer at the top of the shank. Installation commences as the punch proceeds downward against the chamfer of the body. This causes the barbs to spread apart and deform the side wall of the hole to form an undercut in the panel material above the end of the barb. When the punch has reached its final stopping point, the corner tip of the barb will have penetrated into the end wall of the hole. These penetrations of the standoff shank into the panel material lock the fastener into positive rigid engagement with the panel. A second object can be fastened to the top of the fastener by way of a second fastener engaging the threads. This holds the second object a standoff distance away from the panel equal to the height of body of the fastener.

### BRIEF DESCRIPTION OF THE DRAWINGS

FIG. 1 is a partially-sectioned front elevation of a standoff fastener in accordance with a preferred embodiment of the invention;

FIG. 2 is an enlarged fragmentary view taken from FIG. 1;

FIG. 3 is a bottom plan view of the standoff fastener of FIG. 1;

FIG. 4 is a fragmented, partial side elevation schematically illustrating the standoff fastener of FIG. 1 positioned in a receiving panel with the shank extending into the panel's blind receiving hole just prior to installation with a punch; and,

FIGS. 5-9 are fragmented, partial side elevations schematically illustrating the sequential punch positions and deformation conditions of the fastener during installation in accordance with embodiments of the invention.

### DESCRIPTION OF THE PREFERRED EMBODIMENTS

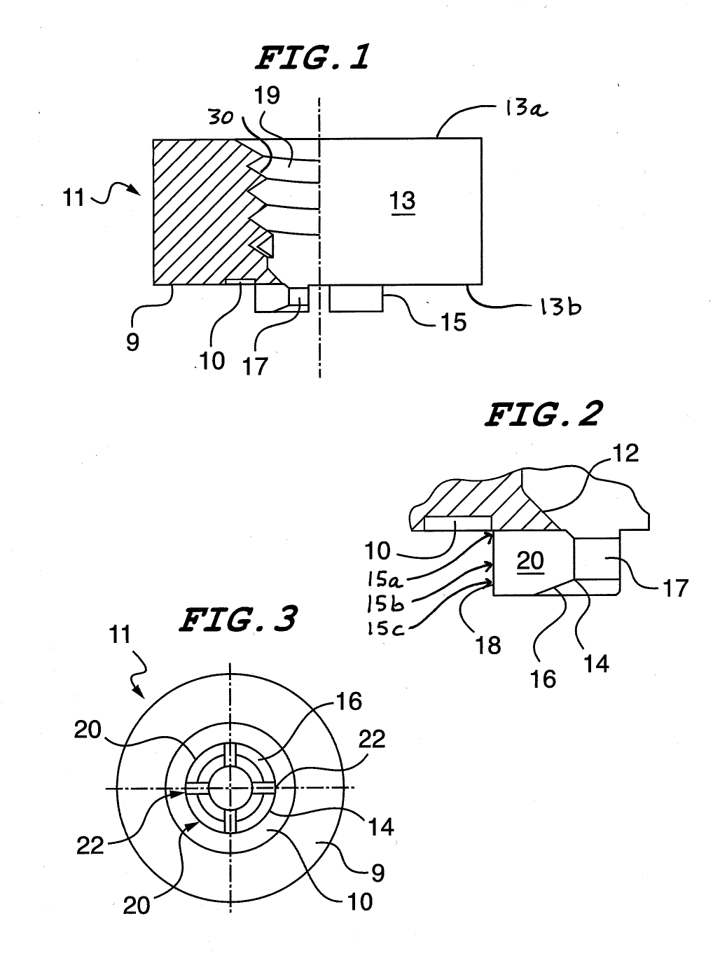

An internally-threaded standoff fastener in accordance with a preferred embodiment of the invention is shown in FIGS. 1-3 and is designated generally by reference numeral 11. Referring to FIG. 1, the fastener 11 is shown in partial section along a central axis of symmetry. The fastener 11 has a substantially-cylindrical body 13 with upper 13a and lower 13b axial ends. A central, threaded bore 19 extends axially through the body 13. The threads 30 of the bore extend from the upper end 13a to a location proximate the lower end 13b. An outer peripheral shoulder 9 is formed on the lower axial end 13b. The shoulder encircles the shank 15 as described below.

A short shank 15 extends axially from the lower end 13b of the body 13. Proceeding axially from the upper to the lower end, the shank has an upper 15a, central 15b and lower portion 15c. The shank 15 has a central internal bore 17 that is preferably co-axial with the internal, threaded bore 19 of the body 13. The central portion 15b of the shank 17 is generally annular with cylindrical inner and outer surfaces. Preferably, the inner surface of the central portion 15b of the shank 15 has a diameter that is less than the minor diameter of the internal threads 30. The upper 15a and lower 15c portions of the shank 15 are generally frustoconical. The outer surface of the upper 15a and lower 15c portions of the shank 15 are cylindrical and coextensive with the outer surface of the central portion 15b, thereby forming a continuous cylindrical outer surface 18 of the shank. The inner surface 12 of the upper 15a portion and the inner surface 16 of the lower 15c portion are chamfered and extend radially relative to the central portion 15b and central axis.

Referring to the orientation shown in FIGS. 1 and 2 and proceeding axially from top to bottom, the first chamfered surface or first chamfer 12 extends radially inwardly while the second chamfered surface or second chamfer 16 extends radially outwardly. The first chamfer 12 extends from the inner wall of the body 13 to the inner wall of the central portion 15b of the shank 15. The second chamfer 16 extends from the inner wall of the central portion 15b to the bottom end of the shank 15. Together, the first chamfer 12, second chamfer 16 and inner wall of the central portion 15b form an inwardly-projecting collar on the shank 15.

Referring to FIG. 2, the second chamfer 16 intersects the inner wall of the central portion 15b at a corner 14 that extends along an inner arcuate edge of the shank 15. As seen in FIGS. 5-9 and described below, the corner 14 engages an end wall of a blind hole in the receiving panel 27.

An annular cavity 10 is formed in the lower end 13b of the body 13 and encircles the shank adjacent to it. In the embodiment shown in FIGS. 1-3, the inner diameter of the cavity 10 is larger than the minor diameter but smaller than the major diameter of the internal threads 30. Preferably, the outer diameter of the cavity 10 is larger than the major diameter of the internal threads 30. The cavity 10 provides a void in the base of the body 13 into which panel material may flow, which allows the panel to cold deform more easily during installation.

As described above, the outer surface 18 of the shank is generally cylindrical; however, as best seen in FIG. 3, the outer surface includes four radial slots 22, which radially divide the shank into four equal segments, which function as panel-engaging barbs 20. This configuration breaks the hoop strength of the annular shank 15 and allows the barbs 20 to more easily spread apart during installation. After installation, panel material 17 is cold-deformed into and occupies the slots 22 to help lock the fastener to the receiving panel 27 and prevent rotation.

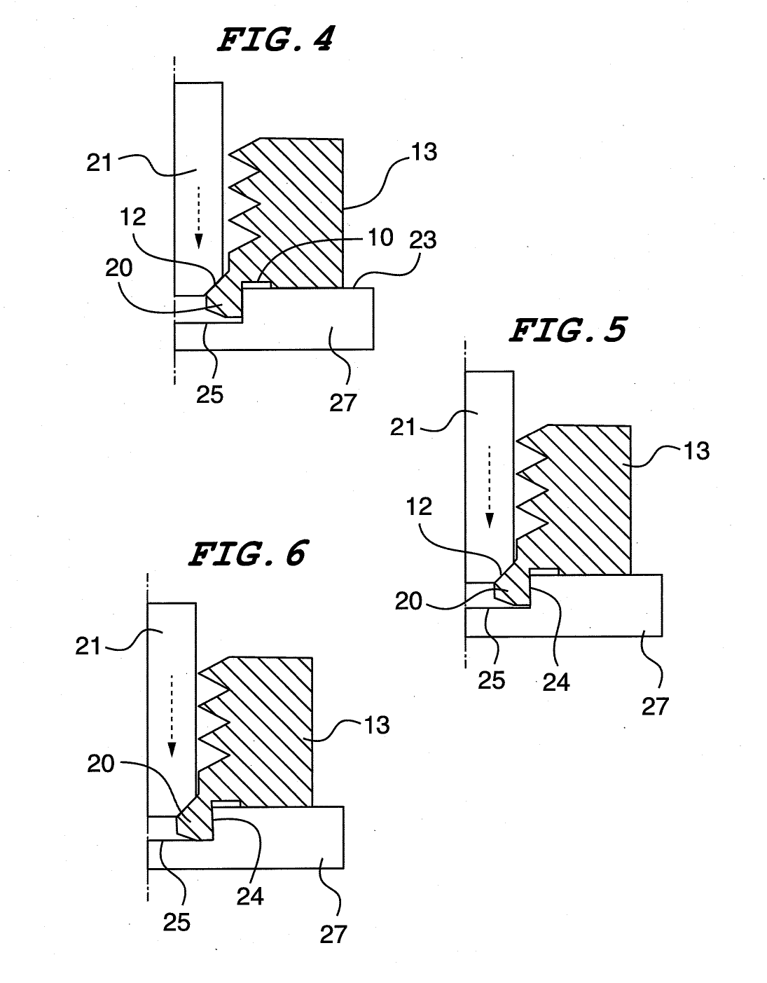

A method of rigidly affixing a metal fastener to a panel in accordance with an embodiment of the invention is schematically illustrated in FIGS. 4-9, which show the sequential punch positions and deformation conditions of the fastener during installation. The punch 21 moves downwardly and presses against the upper chamfer 12 of each barb 20. For purposes of disclosing the method, only one barb is depicted because, as shown in FIG. 3, the fastener 11 is symmetrical about a central axis and all barbs are identical.

FIG. 4 depicts the fastener positioned on the receiving panel 27 with the shank extending into the panel's blind receiving hole having an end wall 25. An installation punch 21 has a matching 45-degree chamfered work surface that engages the upper chamfer 12 on the inside of the shank collar. The panel 27 is normally supported on its underside by an anvil (not shown) which resists the downward force of the punch 21. This position of the punch 21 occurs just before the forcible installation sequence begins.

FIG. 5 depicts the punch moving downwardly against the upper chamfer 12. The reactive force from the top of the panel against the base of the body 13 causes the barbs 20 to spread apart and deform the side wall 24 of the panel hole 25, thereby forming an undercut in the side wall 24 above the end of each barb 20.

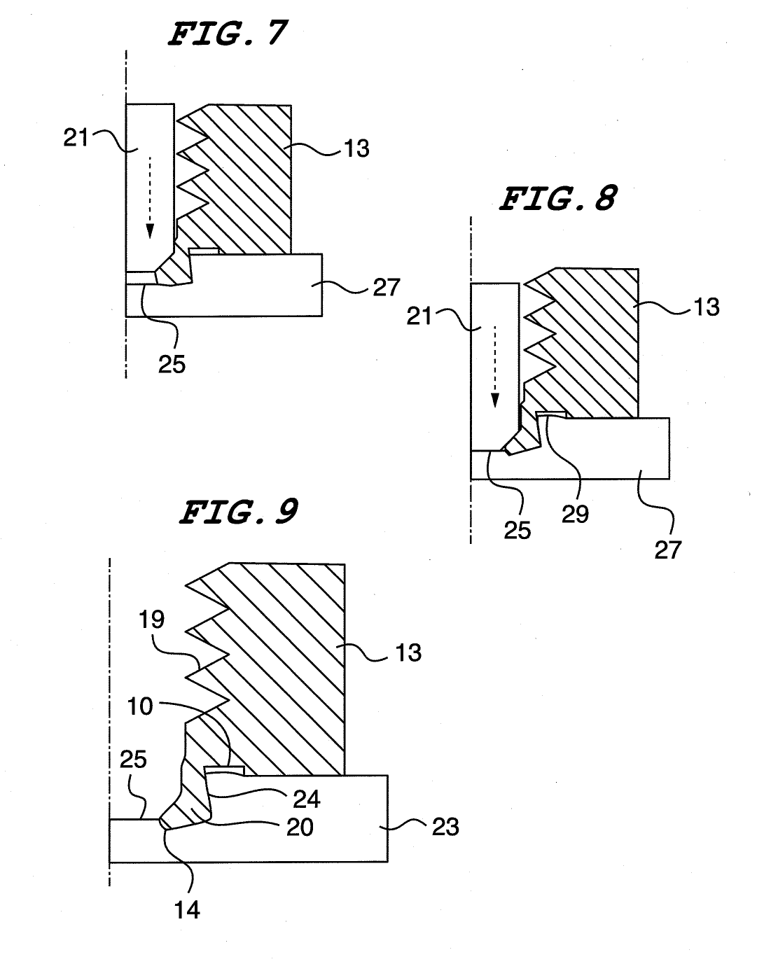

FIGS. 6-9 show the continued, downward progression of the punch and resultant deformation of the fastener 11. During this process, the shank 15 shears by design (well short of failure) and elongates so that the barbs 20 impinge and deform the panel end wall 25 as seen in FIGS. 6 and 7, and deform the side wall 24 as seen in FIG. 7. During this step, the shank both lengthens and deflects outwardly. As the shank flares radially, it bends and rotates about a point above the upper portion of the shank. As the shank rotates, the corner 14 has a tendency to translate both radially outwardly and axially downwardly. However, because the lower portion 15c includes the lower chamfer 16, the corner does not immediately impinge the end wall 25; instead, contact with the end wall 25 is delayed until a more firm grip is achieved between the barbs 20 and the side wall 24. Furthermore, the delayed contact prevents the corner from creating undesirably high stress on the end wall 25.

The annular cavity 10 is important because it creates reduced resistance to the upward, cold-flow of panel material 29 as best seen in FIG. 8. Finally, as seen in FIG. 9, the corner edge 14 of each barb 20 penetrates into the end wall 25 while some additional panel material cold flows upwardly into the cavity 10. In this configuration, since the corner 14 is indented into the end wall 25 and the outer surface of the shank is indented in the side wall 24, the shank cannot more either left or right (radially inwardly or outwardly).

These penetrations of the fastener shank 15 into the panel 27 lock the fastener 11 into positive rigid engagement with the panel 27. This connection also prevents the punch and standoff from sticking together when removing the punch. A second object (such as another panel not shown) may then be secured to the top of the standoff fastener 11 by screwing a male threaded fastener into the central bore 19. This construction secures the second object a distance away from the panel 27 equal to the height of the fastener body 13.

An installation and assembly process in accordance with preferred embodiments is described with specific regard to the relative hardness of the fastener 11 and panel 27. During assembly, the top side of the fastener contacts the punch, and the bottom side of the fastener contacts the substrate panel 27. As seen in the drawings, the punch must plastically deform the fastener, radially flare the fastener shank outwardly, and shear (stretch) the shank downwardly. Therefore, the relative hardness between those parts is important for successful assembly and to achieve the highest performance. In preferred embodiments, the punch should have a hhigher hardness than the fastener 11. The punch is usually made from hardened tool steel with a hardness approaching 55 on a Rockwell C scale (HRC 55). In that case, the fastener hardness could be around HRC 40 (or at least 10 points less hard than the punch hardness on the Rockwell C scale) so that the punch is not damaged during installation. Age-hardened Ti 6Al4V grade 5 is a good example of a fastener material.

Additionally, the fastener must be relatively harder than the substrate panel material and its motion and deformation should be translated in the deformation of the panel material itself every time they are in contact. In other words, the radially-flaring barbs 20 should cold deform the side wall of the panel outwardly and upwardly into the cavity 10. A significant amount of panel deformation is needed before the fastener experiences a significant resistance from the side wall and causes downward shearing. This process ensures firm gripping of the side wall. Therefore, a 25+ point difference in hardness on a Rockwell B scale between the standoff and the panel materials should be used to achieve the intended assembly and performance. Al 6063-T6 is another good example of substrate material assuming the exemplary aforementioned materials of punch and fastener. As seen in FIG. 9, with this hardness difference, the barb corner 16 can easily dig into the end wall 25, thus providing a locking function to resist disengagement of the standoff 11 from the panel 23.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to falling within the claims which alone shall determine the scope of the invention.

1. A unitary clinch nut, comprising:
a body having axial top and bottom ends, a base, a central axis, and an axial threaded bore;
a shank extending downwardly from the base of said body, said shank having a longitudinal bore coaxial with central axis, a cylindrical outer surface, and a collar on the shank projecting radially-inwardly relative to the central axis and having an inner diameter than the diameter of said bore of the body; and
a first chamfer on the top of said collar that is inwardly tapered in the downward direction from the top end to the bottom end.

2. The nut of claim 1 wherein the first chamfer is oriented at a 45-degree angle with respect to the central axis.

3. The nut of claim 3 including a second chamfer on the bottom of said collar that is outwardly tapered in the downward direction from the top end to the bottom end.

4. The nut of claim 1 wherein an area of the nut at the junction of the body and the shank is an area of relative weakness being the least lateral wall thickness of the nut.

5. The nut of claim 4 further including a peripheral shoulder around a base of the body having a cavity therein encircling and adjacent to the shank.

6. The nut of claim 4 further having a cylindrical inner wall of the collar extending between the first and the second chamfers.

7. The nut of claim 6 further having an edge of the collar where the collar and the second chamfer intersect being points along an arcuate line defining the edge.

8. The nut of claim 7 wherein the outside of the shank is otherwise featureless except for a plurality of radial slots dividing the shank into segments forming barbs with panel engagement corners along the edge of the collar.

9. An assembly of a nut and a panel, comprising:
a panel having a cylindrical blind receiving hole with parallel side walls and a substantially planar end wall perpendicular to the side walls; and
a nut having a body with an internally threaded bore and an outwardly flared shank engaging the panel hole side walls and the hole end wall, said nut rigidly affixed to said panel only by the penetration of a bottom outer edge of the shank into the panel side walls and an inner edge of the shank penetrating into the panel end wall.

10. The assembly of claim 9 wherein the nut has a peripheral shoulder around a base of the body that abuts a top side of the panel.

11. An assembly of a nut and a panel, comprising:
a nut according to claim 1;
a panel having a cylindrical blind receiving hole with parallel side walls and a substantially planar end wall perpendicular to the side walls wherein said nut is rigidly affixed to said panel by the penetration of a bottom outer edge of the shank into the panel side walls and an inner edge of the shank collar penetrating into the panel end wall; and
the nut and panel configured such that they are rigidly affixed by pressing the shank of the nut outwardly and downwardly into the panel receiving hole.

12. The assembly of claim 11 wherein the shank is divided into segments separated by axial slots located between adjacent segments such that material of the panel occupies one or more of the slots.

13. The assembly of claim 12 wherein the nut has a peripheral shoulder around a base of the body with a circular cavity adjacent the shank for receiving the cold flow of panel material into the cavity.

14. The method of rigidly affixing a fastener to a panel, comprising the steps of:
placing a bottom side of a panel against an anvil, said panel having a top with an upward facing cylindrical blind hole which has parallel sides and an end wall;
placing a fastener having a body with a threaded axial bore against the panel top surface, said fastener also having a shank with a longitudinal bore, said shank coaxially extending downwardly from the body into the panel hole; and
applying an downward force to a punch passing axially through the body bore, extending into the shank bore and pressing against a collar of the shank whereby the shank is spread outwardly and extended downwardly, penetrating into the sides and the end wall of the panel hole.

15. The method of claim 14 wherein the punch has a tapered pressing head for displacing the collar of the shank outwardly.

16. The method of claim 15 having the additional final step of stopping the downward force to the punch after the punch contacts the hole end wall.

17. The method of claim 16 wherein the punch is constructed such that the panel hole end wall provides a stop against the downward motion of the punch when the shank is fully displaced.
